(19) United States
(12) Patent Application Publication
(10) Pub. No.: US 2007/0225025 A1
(43) Pub. Date: Sep. 27, 2007

(54) Communication system, control device, control method, program, and recording medium

(75) Inventors: Kazuhiro Takahashi, Tokyo (JP); Yoshihiro Ono, Tokyo (JP); Shin Harada, Tokyo (JP); Takashi Shiraki, Tokyo (JP); Takehiko Kashiwagi, Tokyo (JP); Junpei Kamimura, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/724,179

(22) Filed: Mar. 15, 2007

(30) Foreign Application Priority Data
Mar. 24, 2006 (JP) 2006-083718

(51) Int. Cl. H04B 7/00

(52) U.S. Cl. 455/518

(57) ABSTRACT

The present invention provides a communication system, a control apparatus, a program and a recording medium that controls participation in a session using presence information on participation member and information of the session itself. A communication system in which a plurality of communication terminals are connected to each other through a network to establish communication between the communication terminals has a presence information registering section that registers presence information of the communication terminals, a participation condition setting section that sets a participation condition for participating in the communication, a communication information managing section that manages communication information related to a state of the communication, and a communication control section that controls participation in and separation from the communication of the communication terminals.

### BACKGROUND OF THE INVENTION

1. Field of the Invention

The present invention relates to a communication system, a control device, a control method, a program, and a recording medium in a form in which a plurality of users participate in one session like a PoC service or a PoC extended service, and more particularly, to a communication system, a control device, a control method, a program, and a recording medium that administer comings and goings of users based on a state of a session.

2. Description of the Related Art

In recent years, provision of the PoC (Push-to-talk over Cellular) service has been started. Users of the service gradually are increasing. The PoC service is a voice communication service. The voice communication indicates such a communication over transceivers. In the voice communication service, a plurality of users participates in one session, one of the users who obtains a speech right transmits voice, and the voice is transmitted to the other users. The service is well received at the following points. That is, a band is efficiently used, and communication among a plurality of persons is appropriately performed because voices are not mixed with each other.

Some carriers advance the extension of the PoC service, for example, incorporating a multimedia PoC service. The OMA (Open Mobile Alliance), which is an international standard-setting organization, also begins to discuss the extension of services (for example, MA-RD-PoC-V2_{—}0-20060112-D).

Other than the PoC or the PoC extension, another communication service that is built on a session and lumps a plurality of users as participants in one session is spreading from an on-line game.

Methods of selecting session members are roughly classified into three categories. The first method names members at the start point of a session. This method is often called an ad-hoc method. The second method selects a member in advance. This method is often called a pre-arranged method. The third method describes conditions to become a member. These three methods are used separately or combined.

The third method often uses user information or presence information as a condition for participating in a session. For example, in a session for a user support, an employee corresponding to another user at that time is not accepted as a member of the session. When a response to the user ends, i.e., when the presence information changes, the employee is accepted as a member.

As the above-mentioned conventional technique related to a communication service, the methods disclosed in Japanese Patent Application Laid-Open Nos. 2004-178000 (document 1), 2005-115537 (document 2), and 2005-309524 (document 3) are known. Document 1 discloses a reservation system, a reservation device, a reservation method, and a reservation program that automatically display reservation information, depending on an attribute of a user, on a screen, thereby accepting a reservation under a condition relating to the attribute.

Document 2 describes a fire-monitoring system that sets a communication means or a warning means depending on various situations of family members and supports an observer's decision where to make a contact in an emergency.

Furthermore, Document 3 describes an application server, a presence information providing method, and a program that protect privacy and establish real-time communication when presence information is provided.

However, the methods of selecting and designating a session member in conventional communication based on a session as shown in documents 1 to 3 utilize user information such as a name (address). However, information of the session itself is not used. For this reason, in order to establish a session for playing a mah-jong game (a game usually played by four persons), a target session must be started after members are adjusted by another sub-system or the like to gather four members.

### SUMMARY OF THE INVENTION

In consideration of the above problems, it is an objective of the present invention to provide a communication system, a control device, a program and a recording medium that control participation in and separation from communication by using communication information and presence information.

In order to achieve the above objective, provided is a communication system in which a plurality of communication terminals are connected to each other through a network to establish communication between the communication terminals, including presence information registering section that registers presence information of communication terminals, participation condition setting section that sets a participation condition for participating in the communication, communication information managing section that manages communication information related to a state of the communication, and communication control section that controls participation in and separation from the communication of the communication terminals.

The communication control section may control participation in and separation from communication based on the presence information, the participation condition, and the communication information.

When the presence information is changed in the communication system, the communication control section may control participation in and separation from the communication of the communication terminals with reference to the participation condition again.

The communication control section may suspend the communication when the participation condition is not satisfied after the presence information is changed.

When the participation condition is satisfied after the presence information is changed while the communication is suspended, the communication may be resumed.

The participation condition setting section may add a participation condition to the communication already established.

The communication control section may control participation in the communication based on the added new participation condition, the presence information, and the communication information.

There is also provided a communication control device for controlling communication between communication terminals, comprising a participation condition setting section that sets a participation condition for participating in the communication, the communication information managing section that manages communication information related to a state of the communication, and the communication control section that controls participation in and separation from the communication of the communication terminals.

The communication control section may control participation in and separation from the communication based on the presence information, the participation condition, and the communication information.

When the presence information is changed, the communication control section may control participation in and separation from the communication of the communication terminals by referring to the participation condition again.

The communication control section may suspend the communication when the participation condition is not satisfied after the presence information is changed.

The communication may be resumed when the participation condition is satisfied after the presence information is changed while the communication is suspended.

The participation condition setting section may add a new participation condition to the communication already established.

The communication control section may control participation in the communication based on the added new participation condition, the presence information, and the communication information.

There is also provided a method for controlling a communication system in which a plurality of communication terminals, a presence server that registers presence information of the communication terminals, and a communication control device that controls communication between the communication terminals are connected to each other through a network, comprising a participation condition setting step of setting a participation condition for participating in the communication, a communication information managing step of managing communication information related to a state of the communication, and the communication control step of controlling participation in and separation from the communication of the communication terminals.

In the communication control step, participation in and separation from the communication may be controlled based on the presence information, the participation condition, and the communication information.

When the presence information is changed, in the communication control step, participation in and separation from the communication of the communication terminals may be controlled by referring to the participation condition again.

In the communication control step, when the participation condition is not satisfied after the presence information is changed by referring to the participation condition again, the communication may be suspended.

The communication may be resumed when the participation condition is satisfied after the presence information is changed while the communication is suspended.

In the participation condition setting step, a new participation condition may be added to the communication already established.

In the communication control step, participation in the communication may be controlled based on the added new participation condition, the presence information, and the communication information.

There is also provided a computer program for establishing communication between a plurality of communication terminals, causing a computer to perform a participation condition setting process of setting a participation condition for participating in the communication, a communication information managing process of managing communication information related to a state of the communication, and a communication control process of controlling participation in and separation from the communication of the communication terminals.

In the communication control process, participation in and separation from the communication may be controlled based on the presence information, the participation condition, and the communication information.

When the presence information is changed, in the communication control process, participation in and separation from the communication of the communication terminals may be controlled by referring to the participation condition again.

In the communication control process, when the participation condition is not satisfied after the presence information is changed to refer to the participation condition again, the communication may be suspended.

When the participation condition is satisfied after the presence information is changed while the communication is suspended, the communication may be resumed.

In the participation condition setting process, a new participation condition may be added to the communication already established.

In the communication control process, participation in the communication may be controlled based on the added new participation condition, the presence information, and the communication information.

There is also provided a computer readable recording medium storing the program above.

In this manner, according to the communication system, the control device, the control method, the program, and the recording medium of the present invention, since participation in and separation from communication are controlled with communication information and presence information, entries into communication can be more flexibly controlled.

### BRIEF DESCRIPTION OF THE DRAWINGS

FIG. 1 is a block diagram showing a communication system;

FIG. 2 is a block diagram of an example of the communication system;

FIG. 3 is a diagram showing an example of information registered in a presence server;

FIG. 4 is a diagram showing an example of rules set in a participation rule control unit;

FIG. 5 is a diagram showing session information obtained immediately after the start of a session;

FIG. 6 is a diagram showing session information when users B and C participate in a session;

FIG. 7 is a flow chart showing an operation of the communication system;

FIG. 8 is a diagram showing the communication system when user B cannot come to work;

FIG. 9 is a diagram showing session information obtained when user B is separated from the session;

FIG. 10 is a diagram showing session information obtained when user D participates in the session;

FIG. 11 is a flow chart showing an operation of the communication system when user B cannot come to work;

FIG. 12 is a block diagram showing another example of the communication system;

FIG. 13 is a diagram showing another example of information registered in a presence server;

FIG. 14 is a diagram showing another example of a rule set in a participation rule control unit;

FIG. 15 is a diagram showing another example of session information obtained immediately after the start of the session;

FIG. 16 is a diagram showing a case in which a new rule is added to the rules set in FIG. 14;

FIG. 17 is a diagram showing session information obtained when user A is separated from the session;

FIG. 18 is a diagram showing an example of a state of a session when a session is suspended;

FIG. 19 is a diagram showing session information obtained when user B participates in a session;

FIG. 20 is a flow chart showing anther example of the operation of the communication system;

FIG. 21 is a block diagram showing another example of the communication system;

FIG. 22 is a diagram showing still another example of rules set in a participation rule control unit;

FIG. 23 is a diagram showing an example of session information in which a response order is set; and

FIG. 24 is a flow chart showing still another example of the operation of the communication system.

### DETAILED DESCRIPTION OF THE PREFERRED EMBODIMENTS

A communication system, a control device, a control method, a program, and a recording medium according to this embodiment perform session control of participation of a member by combining session information related to a state of a session and presence information (user information) related to information of a participant in the session.

The communication system, the control device, the control method, the program, and the recording medium will be described below with reference to the accompanying drawings. The embodiments are not limited to the following description and can be variably changed without departing from the spirit and scope of the embodiments. The presence information in the embodiments also includes general user information.

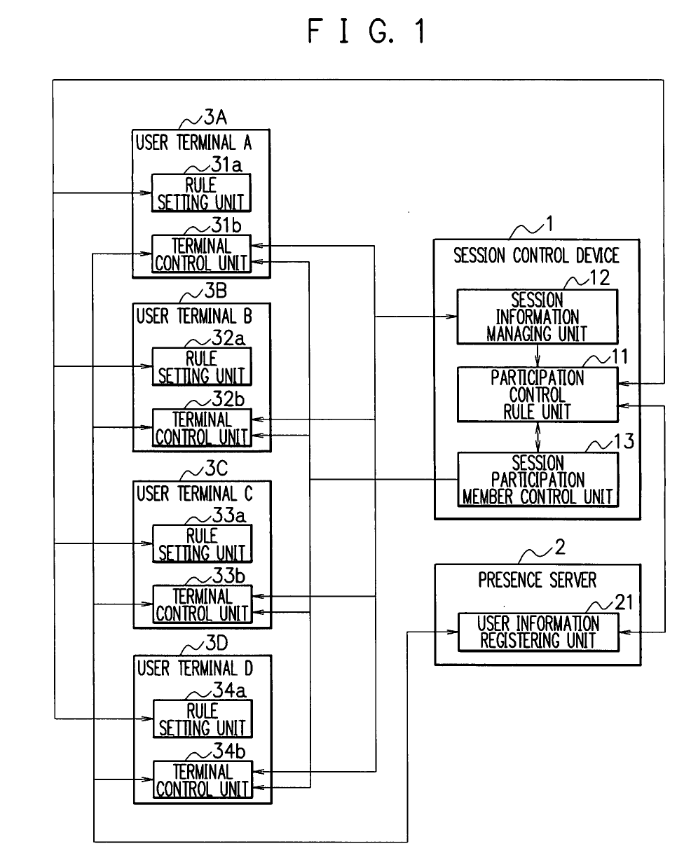

FIG. 1 is a block diagram showing the communication system according to the embodiment.

As shown in FIG. 1, the communication system includes a session control device 1, a presence server 2, and user terminals 3A, 3B, 3C, and 3D. The session control device 1 includes a participation control rule unit 11, a session information managing unit 12, and a session participation member control unit 13. The presence server 2 includes a user information registering unit 21 that registers information of each of the user terminals 3A, 3B, 3C, and 3D. The user terminals 3A to 3D each include rule setting units 31a to 34a and terminal control units 31b to 34b.

The unit 11 controls rules related to a session. The participation into a session is controlled based on rules related to a session set by each of the user terminals 3A to 3D, each user information registered by the unit 21 of the presence server 2, and information related to a present session state from the unit 12. The rule set here may be directly set by each of the user terminals 3A to 3D or may be selected from rules set in advance in the session control device 1 by each of the user terminals 3A to 3D.

The unit 12 is to manage session information. When a session state changes, the unit 12 notifies the participation control rule unit of the change. The unit 13 calls each of the user terminals 3A to 3D on the basis of a designation from the unit 11 to perform participation/nonparticipation, stoppage, continuation, or the like of the session.

The presence server 2 includes the unit 21 and registers pieces of unique information of the user terminals 3A to 3D, respectively. When information (state) of a user terminal changes during a session, the change information is registered in the unit 21. Depending on the registered change information, the unit 11 instructs the unit 13 to suspend or continue a session, or call a new session participant.

Information unique to a user registered in the unit 21 may be provided from a communication terminal having a GPS (Global Positioning System) function, a security function, and the like. In case of the GPS function, user position information is updated and registered at any time by the unit 21 of the presence server 2 and then transmitted to the session control device 1 (unit 11). In case of the security function, for example, when a terminal goes through a security gate, the information that the terminal has gone through the gate is registered in the unit 21 and transmitted to the session control device 1. In this manner, the user information is multilaterally updated at any time, so that the information of the session participant can be obtained in real time.

The units 31a to 34a of the user terminals 3A to 3D set rules for regulating a session member to participate in a session. The rules may be set on the user terminals 3A to 3D, or may be selected by the user terminals 3A to 3D from rules set in advance in the unit 11 depending on a desired session format.

An operation of the communication system will be described below with reference to the accompanying drawings.

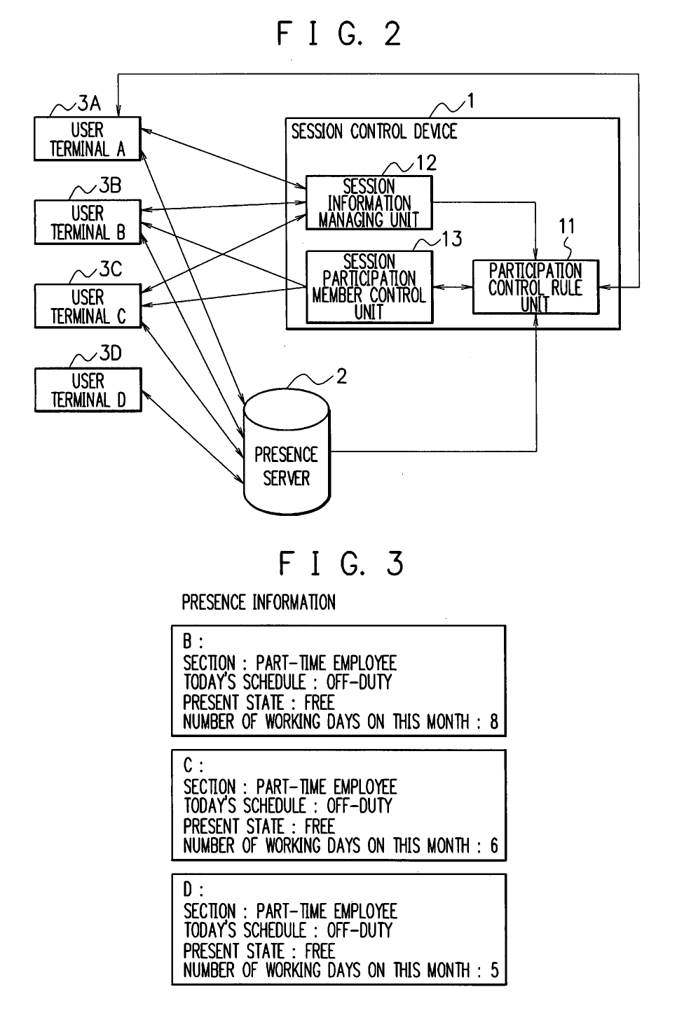

FIG. 2 is a block diagram showing an example of the communication system. In FIG. 2, four user terminals 3A to 3D are arranged, and pieces of information of the user terminals 3A to 3D are registered in a user information storing unit in the presence server 2. Here, users A, B, C, and D (user terminals 3A, 3B, 3C, and 3D) are present. User A is assumed to be a manager of a shop, and users B, C, and D off-duty part-timers.

An example of information registered in the presence server 2 is shown in FIG. 3. As the presence information, user's name, standing, today's plan, a present state, and the number of working days for this month are registered for each user.

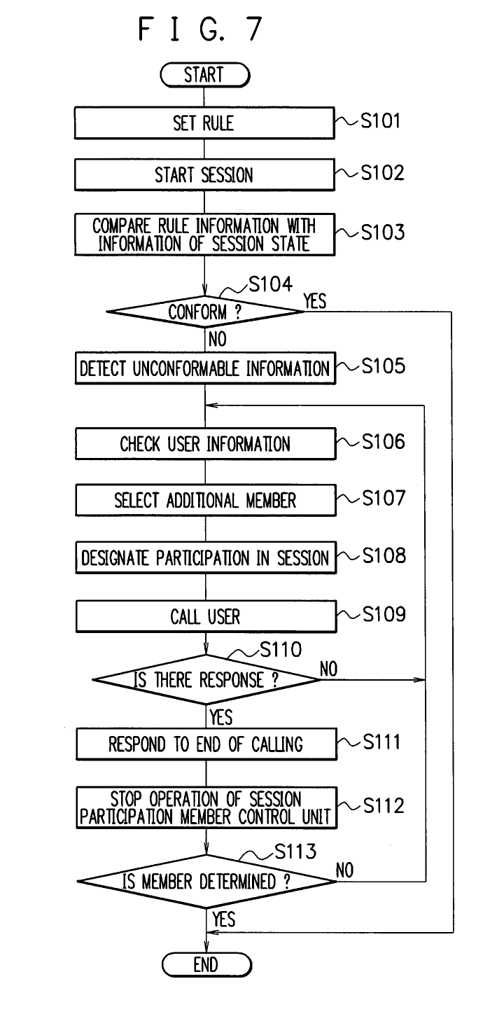

It is assumed that user A is notified that two part-timers on duty on that day cannot come. In this case, workers are short by two. Therefore, in order to find two workers, user A starts a session. FIG. 7 is a flow chart showing an operation of the communication system.

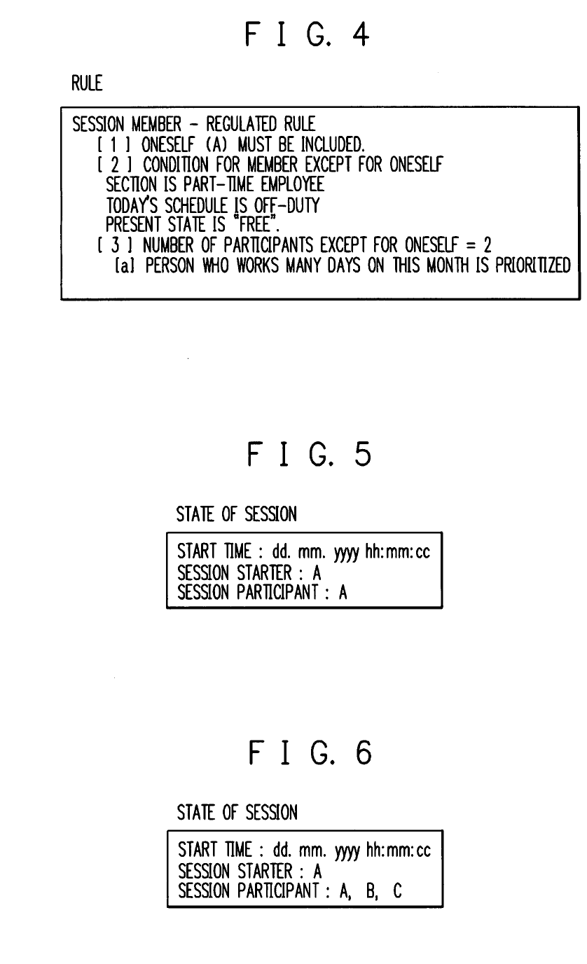

User A set a rule for the unit 11 (step S101). Here, as the rule set by user A, it is designated (set) that “two part-timers who are not busy at present are called” and the session starts (step S102). An example of a rule set at this time is shown in FIG. 4. Session information obtained immediately after the start is shown in FIG. 5.

As shown in FIG. 4, rules are set as follows: [1] oneself (user A in this case) must be included; [2] as a condition for a member except for oneself, (i) the standing is a part-timer, (ii) today's schedule is off-duty, and (iii) the present state is “free”; and [3] the number of participants except for oneself=2, (a) an employee who works for many days is prioritized. As shown in FIG. 5, examples of session information immediately after the start of the session are the start time of the session, information of a session starter, and information of participants.

In the unit 11, information related to a rule designated by the user terminal 3A is compared with information related to a session state in the unit 12 (step S103) to determine whether the pieces of information match (step S104). When the pieces of information match (Yes at step S104), the session is terminated.

When the pieces of information do not match (No at step S104), the session control device 1 detects rules that are not fulfilled (step S105). In this case, the rules [2] and [3] are not fulfilled. For this reason, a process to fulfill the rules [2] and [3] is started.

In order to list up users who satisfy the rule [2], information of each user (user terminal) registered in the unit 21 of the presence server 2 is checked (step S106). In this case, three persons B, C, and D correspond to users who satisfy “standing: part-timer, today's schedule: off-duty, and present state: free”.

According to the rule [3], the condition designated by user A is that two participants except for oneself (A) participate. When the present session information from the unit 12 is viewed, “the number of participants in the present session except for (A)” is 0. Two more must be added. For this reason, two users are selected from the three users (B, C, and D).

According to the condition (a) of the rule [3], users who work for many days in this month are preferentially selected. In this case, as the information of the unit 21, the number of working days of the users are given by B: 8 days, C: 6 days, and D: 5 days. This time users B and C are selected (step S107).

When the users are selected in this manner, the unit 11 instructs the unit 13 to allow users B and C to enter the session (step S108). The unit 13 calls users B and C (step S109). It is checked whether users B and C give some response (step S110).

When there are responses (Yes at step S110), the unit 13 notifies the unit 11 of the end of calling (step S111). When users B and C participate in the session, as shown in FIG. 6, the number of participants in the session except for user A is two, and the condition of the rule [3] is satisfied. Therefore, the unit 13 temporarily stops the operation (step S112). When users B and C accept coming to work (Yes at step S113), user A ends the session.

On the other hand, when there is no response from user B or C (No at step S110), or when users B and C do not accept coming to work, i.e., when members are not determined (No at step S113), the flow goes to step S106 to re-check information of members (users).

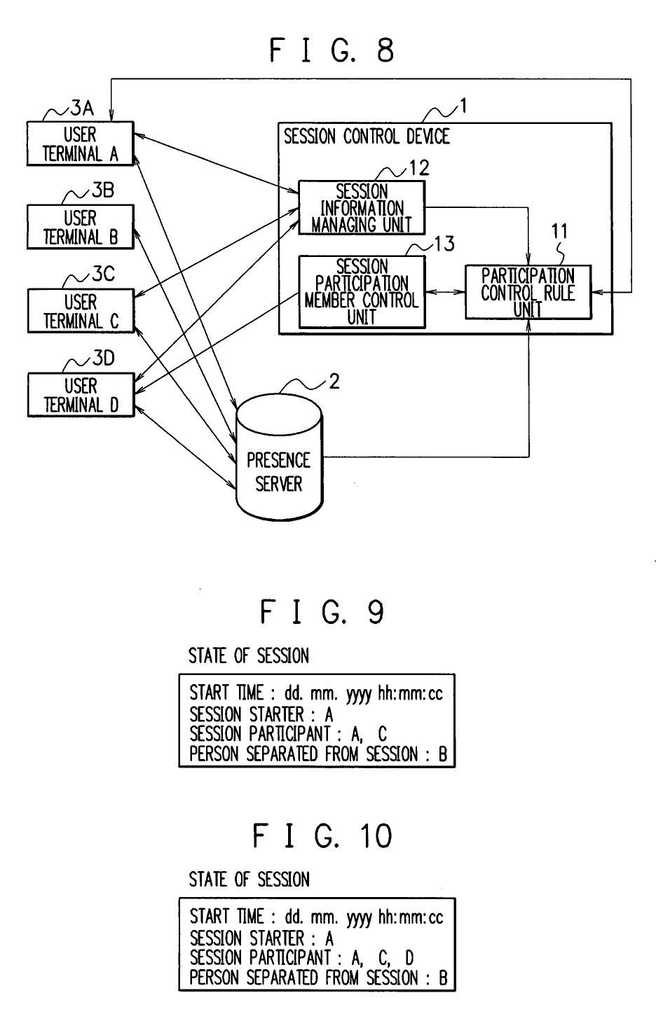

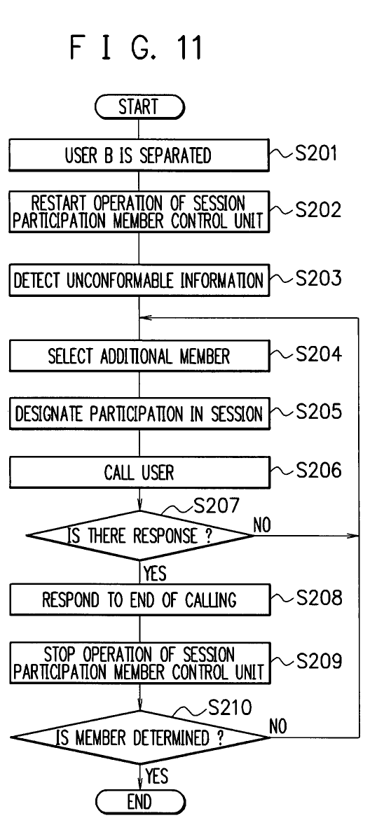

An operation performed when user B cannot come to work will be described. FIG. 8 is a diagram showing a communication system according to an embodiment when user B cannot come to work. FIG. 11 is a flow chart showing an operation of the communication system when user B cannot come to work.

When user B is not available, the rules in the unit 11 of user A are not changed, and the unit 13 separates user B from the session (step S201). The unit 13 may separate user B from the session, or user B may voluntarily disengage from the session.

When user B is separated from the session, as shown in FIG. 9, the session state in the unit 12 changes, the number of called users except for user A is one, i.e., only user C. At this point, the unit 13 restarts the process (step S202).

The process performed after the restart by the unit 13 is almost the same as the process started from step 105 described above. More specifically, the unit 11 detects rules that are not satisfied (step S203). In this case, it is detected that rule [3] is not satisfied. Therefore, the process to satisfy the rule [3] is started.

When a user who satisfies the rule [2] is sought according to the information of the unit 21, users B, C, and D meet the requirement. However, when session information from the unit 12 is checked, it is found that user B has disengaged from the session, and user C is being in the session. Therefore, the remaining candidate for the members is user D.

Therefore, the unit 13 selects user D as a user to be newly called (step S204). The unit 11 instructs the unit 13 to call user D (step S205). The unit 13 calls user D (step S206). It is checked whether there is some response from user D (step S207).

When there is a response from user D (Yes at step S207), the unit 13 notifies the unit 11 of the end of calling (step S208). When user D participates in the session, as shown in FIG. 10, the number of participants in the session except for user A is two, and the condition of the rule [3] is satisfied. Therefore, the unit 13 temporary stops the operation (step S209). When user D accepts to come to work (Yes at step S210), user A ends the session.

On the other hand, when there is no response from user D (No at step S207), or when user D does not accept coming to work, i.e., when the members are not determined (No at step S210), the flow goes to step S204 to select members (users) again.

In this manner, according to the communication system, the session can be maintained in a state desired by user A.

Another operation of the communication system will be described below.

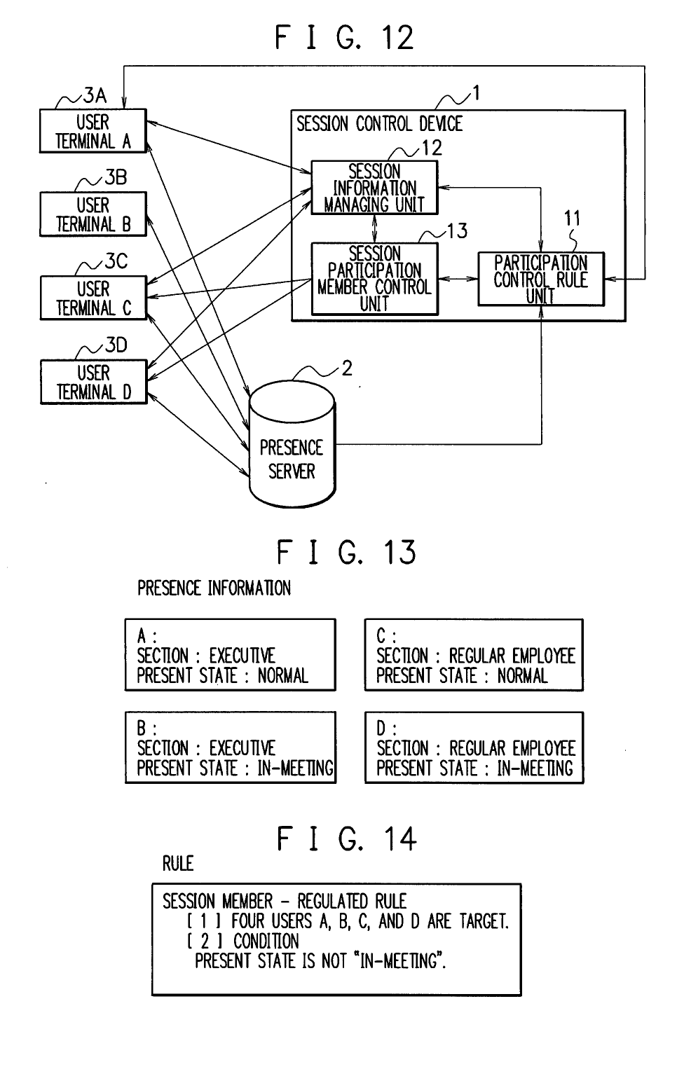

FIG. 12 is a block diagram showing another example of the communication system. In the following explanation, it is assumed that users A, B, C, and D (user terminals 3A, 3B, 3C, and 3D) are present and that users A and B are in administrative position, and users C and D are regular employees. An example of information registered in the presence server 2 is shown in FIG. 13. As presence information, a user name, a rank, and a present state are registered for each user.

It is assumed that user A wishes to hold a meeting by members of a group. Further, it is assumed a member who is seeing his/her customer is not called until the member ends a meeting with his/her customer.

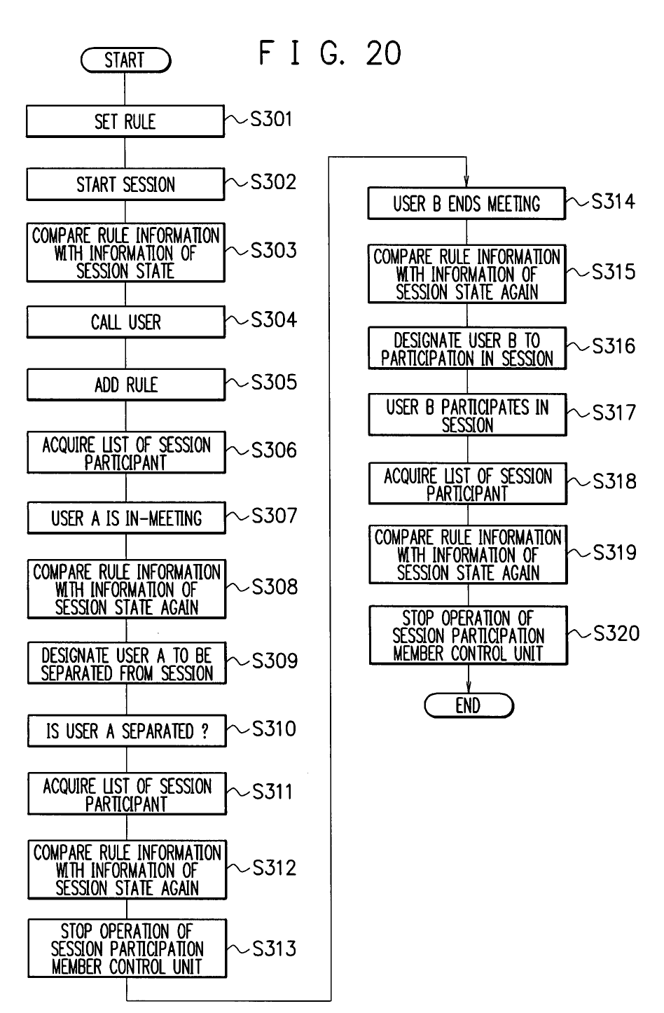

FIG. 20 is a flow chart showing anther example of the operation of the communication system.

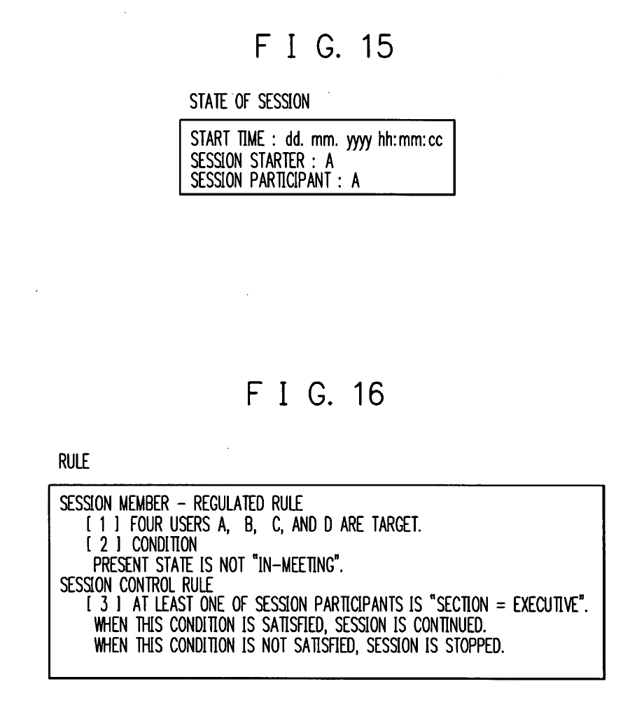

First, user A sets rules to the unit 11 (step S301). In this case, a condition that “a user is a group member and is not meeting his/her customer” is set in the unit 11 to start a session (step S302). An example of the rules is shown in FIG. 14. Session information obtained immediately after the start is shown in FIG. 15.

FIG. 14 shows rules: [1] four users A, B, C, and D are targeted, [2] as a condition for a member, (i) the present state is not “in-meeting”. As shown in FIG. 15, the start time of a session, information of a session starter, and information of session participants are used.

In the unit 11, information related to a rule designated by the user terminal 3A is compared with information related to a session state in the unit 12 to check users A, B, C, and D (step S303). User A has participated in the session, and user B is seeing his/her customer. Therefore, in order to satisfy the above condition, users C and D must participate in the session. Therefore, the unit 11 instructs the unit 13 to call users C and D. In response to this instruction, the unit 13 calls users C and D (step S304). The operation until now is almost the same as that of the above embodiments.

It is assumed that while the meeting is continued by users A, C, and D, discussion about budget starts. It is also assumed that in this group, a person in an administrative position (executive) must be involved in any decision concerning the budget. As shown in FIG. 16, user A adds a rule that [3] at least one of session participants is “rank=executive”, (i) when the condition is satisfied, the session continues, (ii) when the condition is not satisfied, the session suspended (step S305).

On the basis of the rule changed as described above, the session control device 1 acquires a list of session participants in the session information from a session information managing device 4 (step S306). In this case, a list of three users A, C, and D are obtained. Registration information of users A, C, and D is acquired from the presence server 2 to check rules and conditions. Since user A is “rank=executive”, the conditions in the rule [3] are satisfied, and the session continues.

It is assumed that user A is to meet his/her customer. User A changes his/her presence information into “in-meeting” (step S307). The unit 11 is notified that registration information of user A in the unit 21, i.e., the presence information has changed, and the unit 11 re-checks information related to the rule and information related to the session state on the basis of the notification from the unit 21 (step S308).

As a result of the re-checking, user A the present state of which is “in-meeting” is separated from the session on the basis of the rule [2], and the unit 11 instructs the unit 13 to separate user A from the session (step S309). The unit 13 separates user A from the session (step S310).

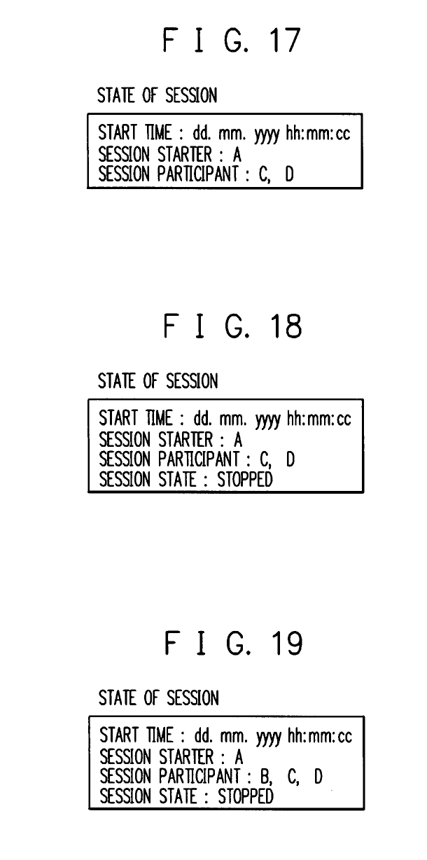

Users remaining in the session are two, i.e., users C and D, and the session information shown in FIG. 17 is obtained. The unit 11 acquires a list of session participation users from the unit 12 (step S311). Two users C and D appears in the list. Registration information of users C and D is acquired from the unit 21 to check the rule and the condition (step S312). Both users C and D are “rank=regular employee”, and “rank=executive” is not present. Therefore, on the basis of the condition of the rule [3], the unit 11 instructs the unit 13 to stop the session to put the unit 13 in abeyance (step S313). The state of the session at this point is shown in FIG. 18.

Furthermore, it is assumed that meeting between a customer and user B is over and that presence information of user B becomes “normal” (step S314). The unit 11 is notified that the registration information of user B in the unit 21, i.e., the presence information, has changed. On the basis of the notification from the unit 21, the unit 11 re-checks information related to the rule and information related to the session information (step S315).

As a result of the re-checking, user B the present state of which is “normal” is to participate in the session on the basis of the rule [2]. The unit 11 instructs the unit 13 to put user B in the session (step S316). The unit 13 puts user B in the session (step S317).

As a result, users participating in the session are three, i.e., users B, C, and D, and the session information shown in FIG. 19 is obtained. The unit 11 acquires a list of session participation users from the unit 12 (step S318). Three users B, C, and D appear in the list. Registration information of users B, C, and D is acquired from the unit 21 to check the rule and the condition (step S319).

Since user B is “rank=executive”, the session is resumed on the basis of the condition of the rule [3]. More specifically, the unit 11 instructs the unit 13 to resume the session to set the unit 13 in a continuation state (step S320).

In this manner, user A maintains a session in a desired state. Furthermore, when necessary conditions are not satisfied, the session is temporarily stopped. When the conditions are satisfied, the session can be resumed.

Still another operation of a communication system will be described below.

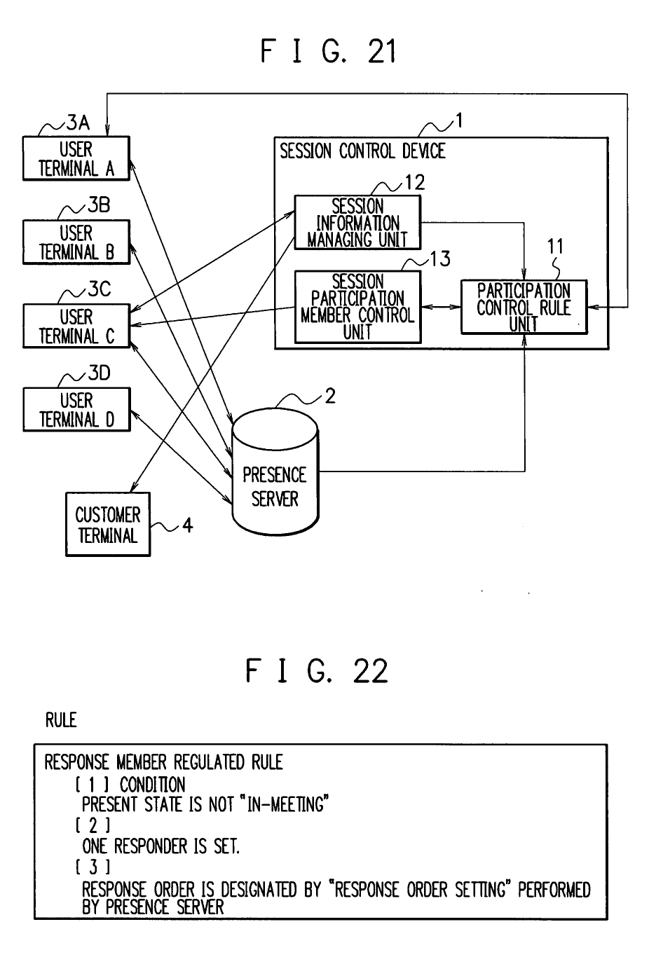

FIG. 21 is a block diagram showing another example of a communication system. It is assumed that users A, B, C, and D (user terminals A, B, C, and D) and a customer (terminal of customer) 4 are present, user A is a team leader, and users B, C, and D are regular members.

When a customer requests a session, user A arranges that one of the members see the customer. An order is determined in consideration of factors such as a degree of busyness, a situation of another work, and the like.

FIG. 24 is a flow chart showing still another example of the operation of a communication system.

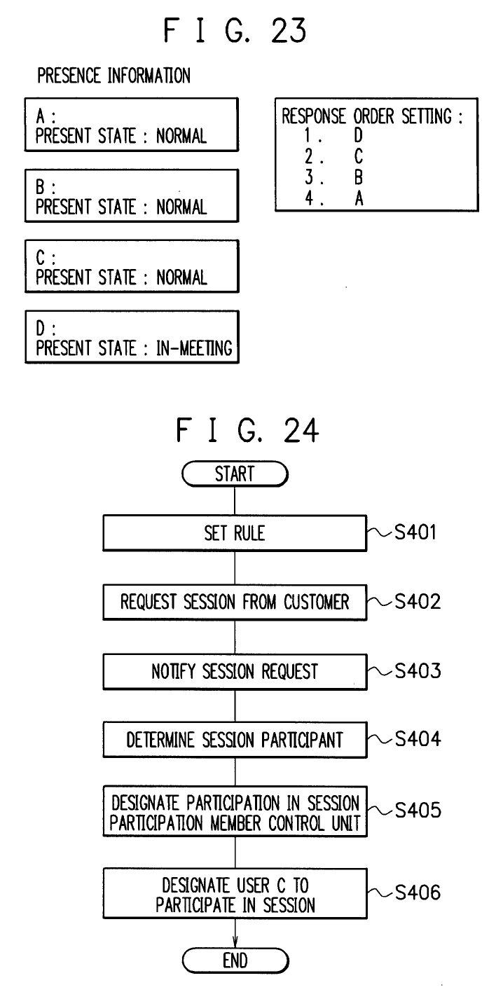

First, user A sets rules to the unit 11 (step S401). Here user A sets a rule that “when a customer requests a session to be started, a member to participate in the session is one who is not seeing a customer and has the highest rank in a response order set by a presence server”. At the same time, a response order is set in the unit 21. FIG. 22 shows an example of rules. FIG. 23 shows a relationship between presence information of each user and a “response order”.

As shown in FIG. 22, rules for responding members are: [1] the present state is not “in-meeting”; [2] one person is needed; and [3] a response order is arranged according to a response order setting in the unit 21 of the presence server 2. As the presence information in the unit 21, user names, present information of each user, and response order settings are registered.

When the customer terminal 4 requests a session (step S402), the unit 12 notifies the unit 11 that the customer terminal 4 requested a session (step S403). The unit 11 chooses participants by using the information of the unit 21 according to the rules shown in FIG. 22 (step S404).

A user who is not seeing his/her customer is selected according to the rule [1], and appropriate users are “users A, B, and C”. According to the rule [3], an order decided based on the response order setting is by “D, C, B, and A”. According to the rule [2], since one person is needed, user C is selected.

When the unit 11 determines that user C participates in a session, the unit 11 instructs the unit 13 to allow user C to participate in the session (step S405). The unit 13 invites user C to participate in a session with the customer terminal 4 (step S406).

In this manner, user A can start a session under desired conditions. When user A changes an order (ranking), priorities of members who respond to customers can be changed without changing rules.

As described above, the communication system, the control device, the control method, the program, and the recording medium of the embodiments use information of a session to control participants in a session and the session itself, and realize a flexible and useful session. More specifically, since not only the presence information of members but also information of a session itself is used to control group members, a participation control rule unit can use the session information to set conditions. In this way, more flexible group member participation control can be performed.

The embodiments are not limited to the above explanations. For example, the number of users may be five or more. In the embodiments, a business scene is considered. However, general consumers may be targeted. In the embodiments, user information, presence information, and preference information (response order) are stored in a presence server. However, these pieces of information each may be stored in different servers.

The presence information, the response order, and the like registered in the unit 21 of the presence server 2 are not limited to those explained in the embodiments. The information and the response order can be properly changed by a user depending on a desired session. This is also applied to rules to be set, and various rules corresponding to modes of sessions can be chosen.

A communication system, a control device, a control method, a program, and a recording medium according to the present invention can also be applied to a general-purpose communication operator, a business communication device manufacturers, service suppliers, and the like.

What is claimed is:

1. A communication system in which a plurality of communication terminals are connected to each other through a network to establish communication, comprising:
presence information registering section that registers presence information of communication terminals;
participation condition setting section that sets a participation condition to participate in the communication;
communication information managing section that manages communication information related to a state of the communication; and
communication control section that controls participation in and separation from the communication of the communication terminals.

2. The communication system according to claim 1, wherein
the communication control section controls participation in and separation from the communication based on the presence information, the participation condition, and the communication information.

3. The communication system according to claim 1, wherein
when the presence information is changed, the communication control section controls participation in and separation from the communication of the communication terminals with reference to the participation condition again.

4. The communication system according to claim 1, wherein
the communication control section suspends the communication when the participation condition is not satisfied after the presence information is changed.

5. The communication system according to claim 4, wherein
when the participation condition is satisfied after the presence information is changed while the communication is suspended, the communication is resumed.

6. The communication system according to claim 1, wherein
the participation condition setting section adds a participation condition to the communication already established.

7. The communication system according to claim 6, wherein
the communication control section controls participation in the communication based on the added new participation condition, the presence information, and the communication information.

8. A communication control device for controlling communication between communication terminals, comprising:
participation condition setting section that sets a participation condition to participate in the communication;
communication information managing section that manages communication information related to a state of the communication; and
communication control section that controls participation in and separation from the communication of the communication terminals.

9. The communication control device according to claim 8, wherein
the communication control section controls participation in and separation from the communication based on the presence information, the participation condition, and the communication information.

10. The communication control device according to claim 8, wherein
when the presence information is changed, the communication control section controls participation in and separation from the communication of the communication terminals by referring to the participation condition again.

11. The communication control device according to claim 8, wherein
the communication control section suspends the communication when the participation condition is not satisfied after the presence information is changed.

12. The communication control device according to claim 11, wherein
when the participation condition is satisfied after the presence information is changed while communication is suspended, the communication is resumed.

13. The communication control device according to claim 8, wherein
the participation condition setting section adds a new participation condition to the communication already established.

14. The communication control device according to claim 13, wherein
the communication control section controls participation in the communication based on the added new participation condition, the presence information, and the communication information.

15. A method for controlling a communication system in which a plurality of communication terminals, a presence server that registers presence information of the communication terminals, and a communication control device that controls communication between the communication terminals are connected to each other through a network, comprising:
a participation condition setting step of setting a participation condition to participate in the communication;
a communication information managing step of managing communication information related to a state of the communication; and
a communication control step of controlling participation in and separation from the communication of the communication terminals.

16. The method according to claim 15, wherein
in the communication control step, participation in and separation from the communication is controlled based on the presence information, the participation condition, and the communication information.

17. The method according to claim 15, wherein
when the presence information is changed, in the communication control step, participation in and separation from the communication of the communication terminals are controlled by referring to the participation condition again.

18. The method according to claim 15, wherein
in the communication control step, when the participation condition is not satisfied after the presence information is changed, the communication is suspended.

19. The method according to claim 18, wherein
the communication is resumed when the participation condition is satisfied after the presence information is changed while the communication is suspended.

20. The method according to claim 15, wherein
in the participation condition setting step, a new participation condition is added to the communication already established.

21. The method according to claim 20, wherein
in the communication control step, participation in the communication is controlled based on the added new participation condition, the presence information, and the communication information.

22. A computer program for establishing communication between a plurality of communication terminals, causing a computer to perform:
a participation condition setting process of setting a participation condition to participate in the communication;
a communication information managing process of managing communication information related to a state of the communication; and
a communication control process of controlling participation in and separation from the communication of the communication terminals.

23. The computer program according to claim 22, wherein
in the communication control process, participation in and separation from the communication are controlled based on the presence information, the participation condition, and the communication information.

24. The computer program according to claim 22, wherein
when the presence information is changed, in the communication control process, participation in and separation from the communication of the communication terminals are controlled by referring to the participation condition again.

25. The computer program according to claim 22, wherein
in the communication control process, when the participation condition is not satisfied after the presence information is changed, the communication is suspended.

26. The computer program according to claim 25, wherein
when the participation condition is satisfied after the presence information is changed while the communication is suspended, the communication is resumed.

27. The computer program according to claim 22, wherein
in the participation condition setting process, a new participation condition is added to the communication already established.

28. The computer program according to claim 27, wherein
in the communication control process, participation in the communication is controlled based on the added new participation condition, the presence information, and the communication information.

29. A computer readable recording medium storing the computer program according to any one of claims 22 to 28.
